(19) United States
(12) Patent Application Publication
(10) Pub. No.: US 2016/0118863 A1
(43) Pub. Date: Apr. 28, 2016

(54) TWO-PHASE ELECTRIC MOTOR COOLER

(71) Applicant: Hamilton Sundstrand Corporation, Charlotte, NC (US)

(72) Inventors: Debabrata Pal, Hoffman Estates, IL (US); Craig R. Legros, Rockford, IL (US)

(21) Appl. No.: 14/524,019

(22) Filed: Oct. 27, 2014

(51) Int. Cl. H02K 9/20; H02K 1/20

(52) U.S. Cl. CPC H02K 9/20; H02K 1/20

(57) ABSTRACT

An electric motor system includes a motor housing and a stator core disposed within the motor housing. The stator core includes a back iron heat exchanger for passing fluid therethrough. A fluid inlet is disposed at a first portion of the back iron heat exchanger that is at least partially in fluid communication with a liquid coolant source and is configured to accept a cooling mixture. A fluid outlet is disposed at a second portion of the back iron heat exchanger for outletting a gas coolant from the back iron heat exchanger such that liquid coolant is convertible to the gas coolant in the back iron heat exchanger by receiving energy from the stator core allowing the gas coolant exit through the outlet and thereby removing heat from the stator core.

### BACKGROUND

1. Field

The present disclosure relates to electric motors, more specifically to thermal management of electric motors.

2. Description of Related Art

Certain aircraft employ electric motors for compressing cabin air and/or for other uses. Traditionally, such electric motors are cooled by passing ram air through cooling channels defined in the back iron of the electric motors. Due to changing atmospheric conditions (e.g., air temperature, humidity), especially on hot and humid days, ram air cooling efficiency is reduced and the motor cannot be cooled sufficiently.

Such conventional methods and systems have generally been considered satisfactory for their intended purpose. However, there is still a need in the art for electric motor heat transfer systems that allow for greater heat transfer control and efficiency. The present disclosure provides a solution for this need.

### SUMMARY

In at least one aspect of this disclosure, an electric motor system includes a motor housing and a stator core disposed within the motor housing. The stator core includes a back iron heat exchanger for passing fluid therethrough. A fluid inlet is disposed at a first portion of the back iron heat exchanger that is at least partially in fluid communication with a liquid coolant source and is configured to accept a cooling mixture. A fluid outlet is disposed at a second portion of the back iron heat exchanger for outletting a gas coolant from the back iron heat exchanger such that liquid coolant is convertible to the gas coolant in the back iron heat exchanger by receiving energy from the stator core allowing the gas coolant exit through the outlet and thereby removing heat from the stator core.

The cooling mixture can include a mixture having about 10% to about 70% liquid or any other suitable mixture. The liquid coolant can include water and/or any other suitable liquid coolant. The cooling mixture can include air and/or any other suitable gas coolant.

In some embodiments, the system can further comprise a condenser in fluid communication with the fluid outlet and the fluid inlet to form a closed loop system. In other embodiments, the fluid inlet and the fluid outlet are not in fluid communication such that the system is an open loop system.

The system can further include a fluid mixer configured to mix air and the liquid coolant upstream of the fluid inlet to create the cooling mixture. The fluid mixer can include a liquid sprayer to spray liquid particles of the liquid coolant into the air such that the cooling mixture includes liquid particles dispersed therein when it enters the fluid inlet.

In some embodiments, the fluid inlet can be defined in the motor housing and includes a plurality of introducers for spraying the cooling mixture into the back iron heat exchanger.

A method for cooling an electric motor system can include introducing a liquid coolant into a back iron heat exchanger of the electric motor, allowing the liquid coolant to convert to a gas coolant within the back iron heat exchanger of the electric motor for absorbing additional thermal energy due to the phase change of the liquid coolant to a gas phase, and exhausting the gas coolant from the back iron heat exchanger through a fluid outlet in fluid communication with the back iron heat exchanger.

Introducing the liquid coolant can include introducing a mixture of air and the liquid coolant. The method can further include reconverting the gas coolant back to a liquid coolant at a condenser. The method can further include releasing the gas coolant from the electric motor system.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic illustration of an embodiment of a close loop cooled electric motor system in accordance with this disclosure, showing a liquid coolant introduction system; and

FIG. 2 is a schematic illustration of an embodiment of an open loop cooled electric motor system in accordance with this disclosure, showing a liquid coolant and air mixer disposed in fluid communication with a fluid inlet of the electric motor system.

### DETAILED DESCRIPTION

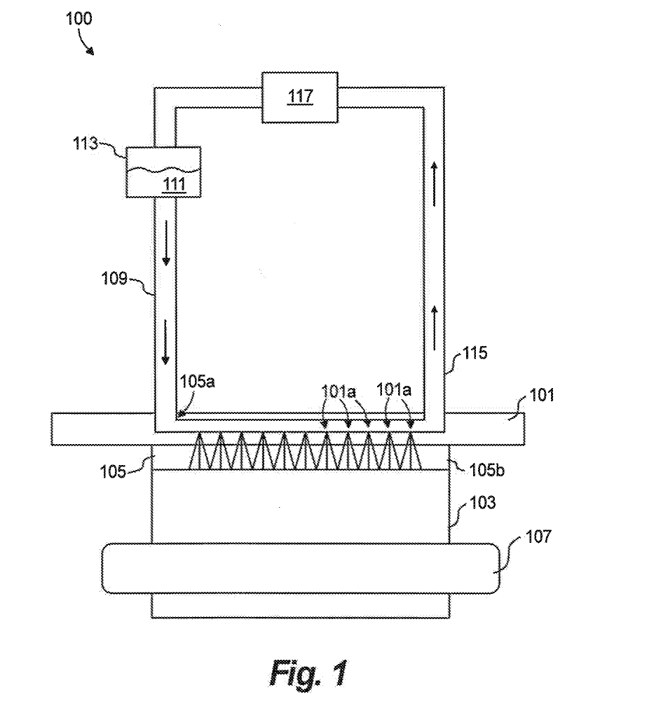

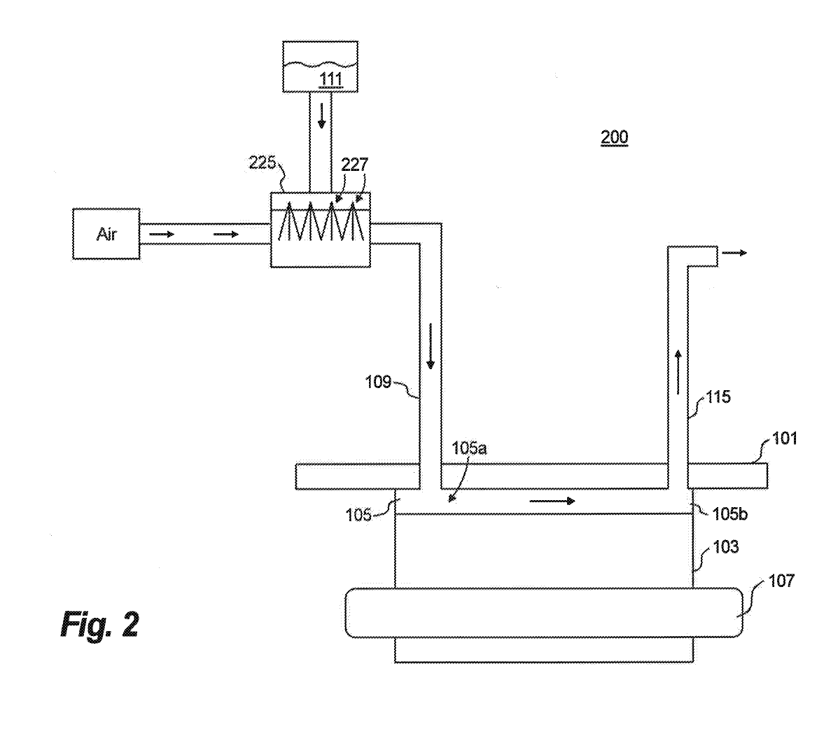

Reference will now be made to the drawings wherein like reference numerals identify similar structural features or aspects of the subject disclosure. For purposes of explanation and illustration, and not limitation, an illustrative view of an embodiment of an electric motor system in accordance with the disclosure is shown in FIG. 1 and is designated generally by reference character 100. Another embodiment of an electric motor system is shown in FIG. 2 and is generally designated reference character 200. The systems and methods described herein can be used to enhance cooling of electric motors/generators compared to traditional systems.

Referring to FIG. 1, in at least one aspect of this disclosure, an electric motor system 100 includes a motor housing 101, a stator core 103 disposed within the motor housing 101 and including a back iron heat exchanger 105 for passing fluid therethrough. While the heat exchanger 105 is referred to as a “back iron” heat exchanger, this term of art is defined herein as any suitable heat exchanger made of any suitable material (e.g., aluminum), not simply iron. One or more stator windings 107 can be disposed within the stator core 103.

A fluid inlet 109 can be disposed at a first portion 105a of the back iron heat exchanger 105 and can be at least partially in fluid communication with a liquid coolant 111 from a coolant source 113. The fluid inlet 109 and is configured to accept a cooling mixture to allow the liquid coolant 111 or a mixture of the liquid coolant 111 and a gas (e.g., air) to enter into the back iron heat exchanger 105.

As shown in FIG. 1, the liquid coolant 111 is fed to the inlet 109 in a liquid state such that the cooling mixture introduced into the back iron heat exchanger 105 is liquid. However, it is contemplated that the embodiment of FIG. 1 can be configured to operate with any suitable mixture of liquid and gas coolant.

In some embodiments, as shown in FIG. 1, the fluid inlet 109 can be at least partially defined in the motor housing 101 and can include a plurality of introducers 101a for spraying the cooling mixture into the back iron heat exchanger 105.

The system 100 further includes a fluid outlet 115 disposed at a second portion 105b of the back iron heat exchanger 105 for accepting a gas (e.g., liquid coolant 111 that has been converted to gas) from the back iron heat exchanger 105 such that the liquid coolant 111 can be converted to gas in the back iron heat exchanger 105 by receiving energy from the stator core 103 allowing the gas to exit through the outlet 115 and thereby removing heat from the stator core 103.

As shown in FIG. 1, the system 100 can be a closed loop system such that a liquid portion of the at least partially liquid coolant is recycled within the system 100 using a condenser 117 fluidly connecting the fluid outlet 115 to the fluid inlet 109 and/or to the coolant source 113. In such an embodiment, gas coolant flowing through the outlet 115 can be routed to a suitable condenser 117 (e.g., a power electronics cooling system (PECS) heat exchanger) for removal of heat from the gas coolant and conversion back into the liquid coolant 111.

In other embodiments, as shown in FIG. 2, a system 200 can be an open loop such that the gas coolant is discharged from the system 200 through the fluid outlet 105. As shown, the system 200 can further include a fluid mixer 225 configured to mix air and the liquid coolant 111 ahead of the fluid inlet 109 to create a partially liquid cooling mixture. The fluid mixer 225 can include a liquid sprayer 227 to spray liquid particles of the liquid coolant 111 into the air such that the partially liquid cooling mixture includes liquid particles dispersed therein when it enters the fluid inlet 109.

The cooling mixture can be more than about 50% liquid or any other suitable mixture by volume (e.g., less than about 50%, less than about 10%, about 100%, about 75%). In some embodiments, the cooling mixture includes about 10% to about 70% liquid. The ratio of liquid coolant 111 to air or other gas can be controlled to achieve a desired specific heat and/or thermal transfer due to the latent heat of evaporation. For example, the cooling mixture can be saturated with the liquid coolant to ensure that all liquid coolant 111 converts to gas inside the back iron heat exchanger 105. The system 200 can include a feedback system for determining how much liquid coolant 111 to add to the air flow in the mixer 225 based on any suitable characteristic (stator core temperature, outflow gas properties, temperature, or the like).

The liquid coolant 111 can include water and/or any other suitable liquid coolant (e.g., a refrigerant). Any suitable gas coolant (e.g., air as shown) can be mixed with the liquid coolant in the mixer 225.

In accordance with at least one aspect of this disclosure, a method for cooling an electric motor system 200 can include introducing a liquid coolant 111 into a back iron heat exchanger 105 of the electric motor, allowing the liquid coolant 111 to convert to a gas coolant within the back iron heat exchanger 105 of the electric motor for absorbing additional thermal energy due to the phase transfer of the liquid coolant 111 to a gas phase, and exhausting the gas coolant from the back iron heat exchanger 105 through a fluid outlet 115 in fluid communication with the back iron heat exchanger 105.

Introducing the liquid coolant 111 can include introducing a mixture of air and the liquid coolant 111. The method can further include reconverting the gas coolant back to a liquid coolant 111 at a condenser (e.g., condenser 117 as shown in FIG. 1). The method can further include releasing the gas coolant from the electric motor system 200.

The methods and systems of the present disclosure, as described above and shown in the drawings, provide for cooling systems for electric motors/generators with superior properties including improved thermal transfer efficiency. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. An electric motor system, comprising:
a motor housing;
a stator core disposed within the motor housing and including a back iron heat exchanger for passing fluid therethrough;
a fluid inlet disposed at a first portion of the back iron heat exchanger that is at least partially in fluid communication with a liquid coolant source and is configured to accept a cooling mixture; and
a fluid outlet disposed at a second portion of the back iron heat exchanger for outletting a gas coolant from the back iron heat exchanger such that liquid coolant is convertible to the gas coolant in the back iron heat exchanger by receiving energy from the stator core allowing the gas coolant exit through the outlet and thereby removing heat from the stator core.

2. The system of claim 1, wherein the cooling mixture is a mixture including about 10% to about 70% liquid.

3. The system of claim 1, wherein the liquid coolant includes water.

4. The system of claim 1, wherein the cooling mixture includes air.

5. The system of claim 1, further comprising a condenser in fluid communication with the fluid outlet and the fluid inlet to form a closed loop system.

6. The system of claim 1, wherein the fluid inlet and the fluid outlet are not in fluid communication such that the system is an open loop system.

7. The system of claim 1, further including a fluid mixer configured to mix air and the liquid coolant ahead of the fluid inlet to create the cooling mixture.

8. The system of claim 7, wherein the fluid mixer includes a liquid sprayer to spray liquid particles of the liquid coolant into the air such that the cooling mixture includes liquid particles dispersed therein when it enters the fluid inlet.

9. The system of claim 8, wherein the fluid inlet is defined in the motor housing and includes a plurality of introducers for spraying the cooling mixture into the back iron heat exchanger.

10. A method for cooling an electric motor system, comprising:
introducing a liquid coolant into a back iron heat exchanger of the electric motor;
allowing the liquid coolant to convert to a gas coolant within the back iron heat exchanger of the electric motor for absorbing additional thermal energy due to the phase transfer of the liquid coolant to a gas phase; and
exhausting the gas coolant from the back iron heat exchanger through a fluid outlet in fluid communication with the back iron heat exchanger.

11. The method of claim 10, wherein introducing the liquid coolant includes introducing a mixture of air and the liquid coolant.

12. The method of claim 10, further comprising reconverting the gas coolant back to a liquid coolant at a condenser.

13. The method of claim 10, further comprising releasing the gas coolant from the electric motor system.
